(19) United States
(12) Patent Application Publication
(10) Pub. No.: US 2021/0062539 A1
(43) Pub. Date: Mar. 4, 2021

(54) Positioning Structure for Lock Deadbolt

(71) Applicant: Jeff Chen, Chiayi City (TW)

(72) Inventor: Jeff Chen, Chiayi City (TW)

(21) Appl. No.: 16/555,044

(22) Filed: Aug. 29, 2019

(51) Int. Cl. E05B 15/10; E05B 63/00

(52) U.S. Cl. CPC E05B 15/10; E05B 63/0056; E05B 63/0017

(57) ABSTRACT

A positioning structure for a lock deadbolt contains: a body, an actuation device, a rotation member, and a locking head. The body includes a base, an actuation section, an accommodation chamber, two slots, two first orifices, two limitation sheets, and two defining recesses. The actuation device includes a driving segment, an extension, and two wings. The driving segment has a connection portion, and the extension has a notch. The rotation member includes a swing column, a post radially, a rotary seat, a first shoulder, and a second shoulder. The rotary seat slides in the two defining recesses of the body. When the rotary seat rotates positively and reversely, the first shoulder and the second shoulder stop the two limitation sheets of the body respectively in a corner stopping manner. The rotation member further includes a cross groove. The locking head includes a coupling portion and a driven portion.

### BACKGROUND OF THE INVENTION

### Field of the Invention

The present invention relates to a positioning structure for a lock deadbolt which contains a rotation member and a locking head configured to match with the rotation member for a long period of using time so as to avoid a deformation of a base of a body and to enhance rigidity of the body.

### Description of the Prior Art

A conventional lock contains components which are not changeable and applicable for doors of various specifications.

A conventional lock deadbolt contains a body, an extension extending from a first end of the body, and a pull plate extending from a second end of the body, wherein the pull plate actuates the extension. The pull plate has two support sheets mounted on a front side and a rear side thereof respectively, and a drive piece defined between the two support sheets and having a C-shaped cross section. The drive piece having a C-shaped cross section actuates a rotatable button, and the two support sheets have two circularly elongated orifices defined thereon respectively so that the rotatable button is inserted through the two circularly elongated orifices. However, the central drive rod of a lock is inserted through the rotatable button, so the two support sheets deform after using the conventional lock deadbolt for a long period of time, thus causing malfunction of the extension.

The present invention has arisen to mitigate and/or obviate the afore-described disadvantages.

### SUMMARY OF THE INVENTION

The primary objective of the present invention is to provide a positioning structure for a lock deadbolt which a body, an actuation device, a rotation member, and a locking head, the body matches with the actuation device, the locking head, and the rotation member so as to simplify and adjust the lock deadbolt, the accommodation chamber of the body includes the two limitation sheets, when the rotation member rotates positively and reversely, the first shoulder and the second shoulder stop the two limitation sheets of the body respectively in a corner stopping manner, and the actuation device is actuated to drive the locking head to expend and retract in the body, by which a door is unlocked or locked; and the locking head matches with the rotation member for a long period of using time so as to avoid a deformation of the base of the body and a malfunction of the locking head and the actuation device.

### BRIEF DESCRIPTION OF THE DRAWINGS

FIG. 1 is a perspective view showing the assembly of a positioning structure for a lock deadbolt according to a preferred embodiment of the present invention.

FIG. 2 is another perspective view showing the assembly of the positioning structure for the lock deadbolt according to the preferred embodiment of the present invention.

FIG. 3 is a perspective view showing the exploded components of the positioning structure for the lock deadbolt according to the preferred embodiment of the present invention.

FIG. 4 is a perspective view showing the assembly of a part of the positioning structure for the lock deadbolt according to the preferred embodiment of the present invention.

FIG. 5 is a cross-sectional perspective view showing the assembly of a part of the positioning structure for the lock deadbolt according to the preferred embodiment of the present invention.

FIG. 6 is another cross-sectional perspective view showing the assembly of a part of the positioning structure for the lock deadbolt according to the preferred embodiment of the present invention.

FIG. 7 is a cross-sectional view showing the operation of the positioning structure for the lock deadbolt according to the preferred embodiment of the present invention.

FIG. 8 is another cross-sectional view showing the operation of the positioning structure for the lock deadbolt according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

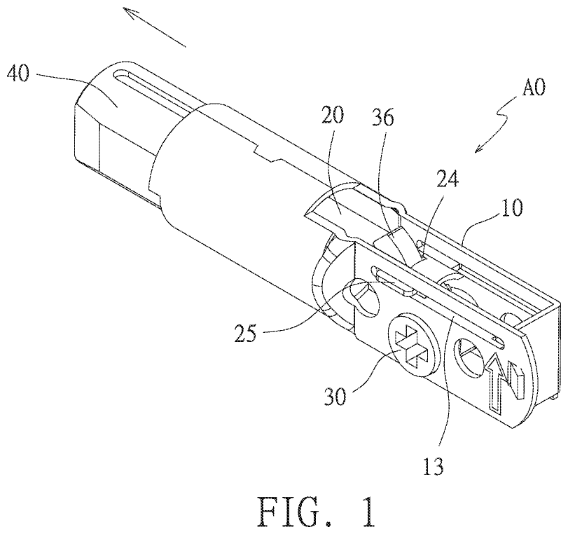

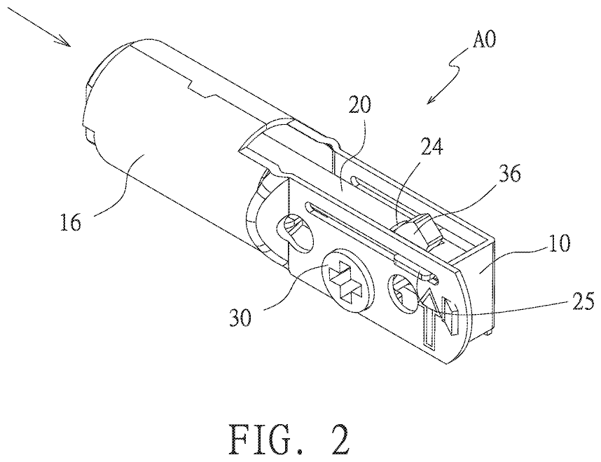

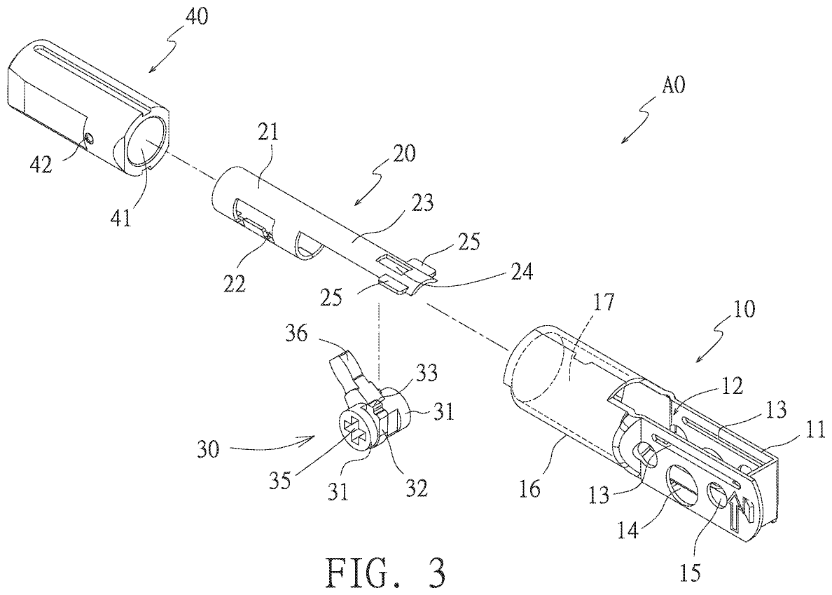

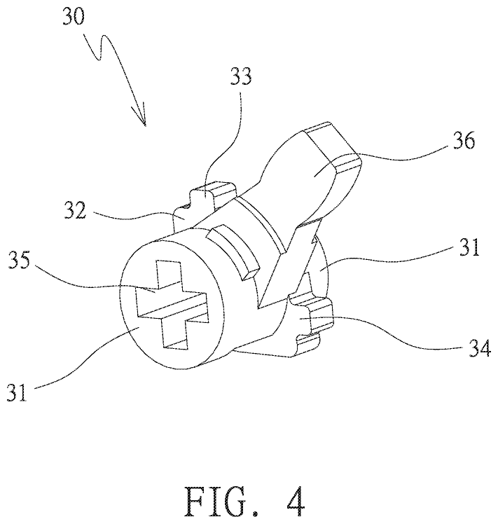

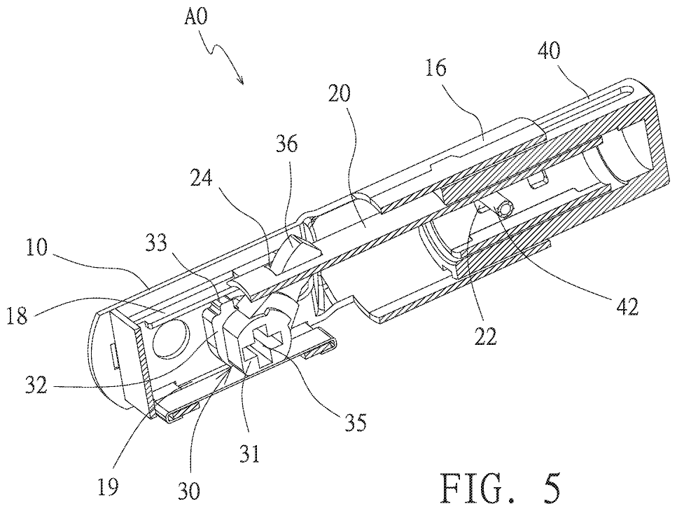

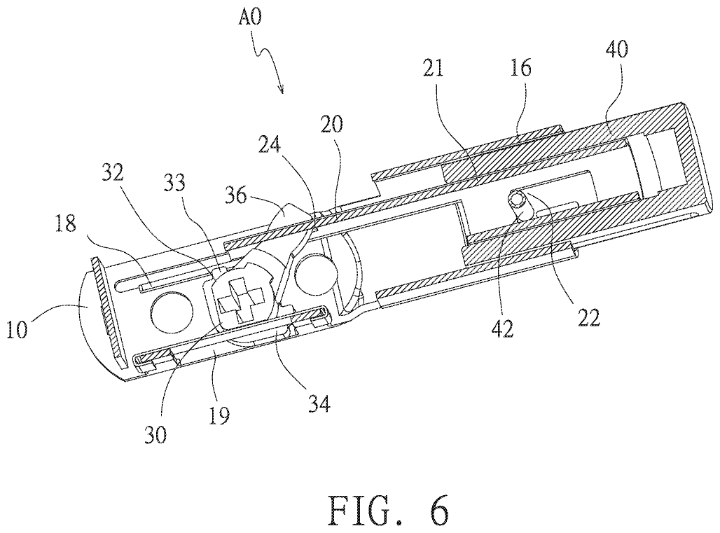

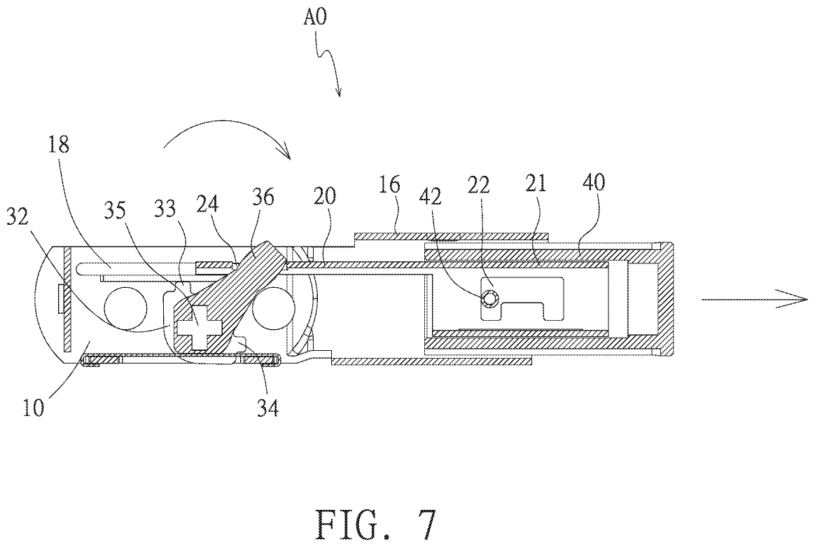

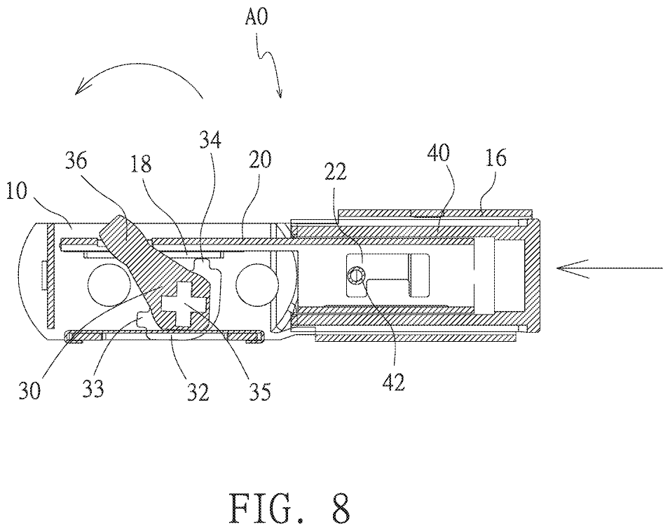

With reference to FIGS. 1-8, a positioning structure AO for a lock deadbolt according to a preferred embodiment of the present invention comprises:

a body 10 including a base 11, an actuation section 16 formed on an end of the base 11, an accommodation chamber 12 defined inside the base 11, two slots 13 passing through two sides of the base 11 respectively and communicating with the accommodation chamber 12, two first orifices 14 formed below the two slots 13 individually, two second orifices 15 defined besides the two first orifices 14 respectively, two limitation sheets 18 extending from two bottoms of the two slots 13 respectively, and two defining recesses 19 defined inside a bottom of the base 11 opposite to the two limitation sheets 18 respectively;

an actuation device 20 including a driving segment 21 formed on a first end of the actuation device 20, an extension 23 extending on a second end of the actuation device 20, two wings 25 extending from two sides of a distal end of the extension 23, the driving segment 21 being accommodated in a drive space 17 of the body 10 so that the driving segment 21 moves in the drive space 17 forward and backward, and the two wings 25 being received and slidably moving in the two slots 13 of the body 10, wherein the driving segment 21 has a connection portion 22 formed on a predetermined position thereof, and the extension 23 has a notch 24 defined thereon adjacent to the distal end of the extension 23;

a rotation member 30 including a swing column 31 rotatably connected with the two first orifices 14 of the body 10, a post 36 radially extending from a predetermined position of the swing column 31 and movably extending out of the notch 24 of the actuation device 20, a rotary seat 32 extending from a side of the swing column 31, a first shoulder 33 extending from a first end of the rotary seat 32, and a second shoulder 34 extending from a second end of the rotary seat 32, wherein when the rotary seat 32 rotates, it slides in the two defining recesses 19 of the body 10, when the rotary seat 32 rotates positively and reversely, the first shoulder 33 and the second shoulder 34 stop the two limitation sheets 18 of the body 10 respectively in a corner stopping manner; the rotation member 30 further includes a cross groove 35 passing through two sides of the swing column 31, wherein the cross groove 35 accommodates a rotatable operation element of a key (not shown) so as to drive the cross groove 35 and the rotation member 30 to rotate positively and reversely;

a locking head 40 including a coupling portion 41 formed on an end of the locking head 40 and fitted with the driving segment 21 of the actuation device 20, and a driven portion 42 corresponding to the connection portion 22 of the actuation device 20 so that when the coupling portion 41 is fitted with the driving segment 21 of the actuation device 20, the driven portion 42 is connected with the connection portion 22 of the actuation device 20.

The body 10 matches with the actuation device 20, the locking head 40, and the rotation member 30 so as to simplify and adjust the lock deadbolt. The accommodation chamber 12 of the body 10 includes the two limitation sheets 18, when the rotation member 30 rotates positively and reversely, the first shoulder 33 and the second shoulder 34 stop the two limitation sheets 18 of the body 10 respectively in the corner stopping manner, and the actuation device 20 is actuated to drive the locking head 40 to expend and retract in the body 10, by which a door is unlocked or locked. Preferably, the locking head 40 matches with the rotation member 30 for a long period of using time so as to avoid a deformation of the base 11 of the body 10 and a malfunction of the locking head 40 and the actuation device 20.

While various embodiments in accordance with the present invention have been shown and described, it is clear to those skilled in the art that further embodiments may be made without departing from the scope of the present invention.

What is claimed is:

1. A positioning structure for a lock deadbolt comprising:
a body including a base, an actuation section formed on an end of the base, an accommodation chamber defined inside the base, two slots passing through two sides of the base respectively and communicating with the accommodation chamber, two first orifices formed below the two slots individually, two second orifices defined besides the two first orifices respectively, two limitation sheets extending from two bottoms of the two slots respectively, and two defining recesses defined inside a bottom of the base opposite to the two limitation sheets respectively;
an actuation device including a driving segment formed on a first end of the actuation device, an extension extending on a second end of the actuation device, two wings extending from two sides of a distal end of the extension, the driving segment being accommodated in a drive space of the body so that the driving segment moves in the drive space forward and backward, and the two wings being received and slidably moving in the two slots of the body, wherein the driving segment has a connection portion formed on a predetermined position thereof, and the extension has a notch defined thereon adjacent to the distal end of the extension;
a rotation member including a swing column rotatably connected with the two first orifices of the body, a post radially extending from a predetermined position of the swing column and movably extending out of the notch of the actuation device, a rotary seat extending from a side of the swing column, a first shoulder extending from a first end of the rotary seat, and a second shoulder extending from a second end of the rotary seat, wherein when the rotary seat rotates, the rotary seat slides in the two defining recesses of the body, when the rotary seat rotates positively and reversely, the first shoulder and the second shoulder stop the two limitation sheets of the body respectively in a corner stopping manner; the rotation member further includes a cross groove passing through two sides of the swing column; and
a locking head including a coupling portion formed on an end of the locking head and fitted with the driving segment of the actuation device, and a driven portion corresponding to the connection portion of the actuation device so that when the coupling portion is fitted with the driving segment of the actuation device, the driven portion is connected with the connection portion of the actuation device.
